(19) United States
(12) Patent Application Publication
(10) Pub. No.: US 2011/0310412 A1
(43) Pub. Date: Dec. 22, 2011

(54) IMAGE FORMING APPARATUS, NOISE CANCELLATION METHOD, AND RECORDING MEDIUM

(75) Inventors: Hiroshi EGUCHI, Okazaki-shi (JP); Shigeru YAMAZAKI, Toyokawa-shi (JP); Tomonobu TAMURA, Toyokawa-shi (JP); Yuhei TATSUMOTO, Toyokawa-shi (JP)

(73) Assignee: Konica Minolta Business Technologies, Inc., Chiyoda-ku (JP)

(21) Appl. No.: 13/161,909

(22) Filed: Jun. 16, 2011

(30) Foreign Application Priority Data
Jun. 22, 2010 (JP) 2010-141261

(51) Int. Cl. G06K 15/02

(52) U.S. Cl. 358/1.9

(57) ABSTRACT

An image forming apparatus comprising: a sound-level meter that measures operating noise of a rotating portion; a sound data generator that generates a noise control sound data object with the same amplitude but with the inverted phase to the operating noise; a speaker that emits sound based on the noise control sound data object; a memory that stores in advance a noise control sound data object generated to cancel out operating noise measured while the rotation frequency of the rotating portion is changed from a first rate to a second rate; and a controller that measures operating noise of the rotating portion and generates a noise control sound data object to cancel out the operating noise, then emits sound based on the noise control sound data object, while the rotating portion runs in steady state, meanwhile reads out from the memory, a suitable noise control sound data object from the memory and emit sound based on the noise control sound data object, during the transition of the rotation frequency of the rotating portion.

This application claims priority under 35 U.S.C. §119 to Japanese Patent Application No. 2010-141261 filed on Jun. 22, 2010, the entire disclosure of which is incorporated herein by reference in its entirety.

### BACKGROUND OF THE INVENTION

1. Technical Field

The present invention relates to: an image forming apparatus such as a MFP (Multi Function Peripheral) or the like, which is a multifunctional digital image forming apparatus provided with a noise cancellation function whereby operating noise of a rotating portion such as a fan can be cancelled out; a noise cancellation method for the image forming apparatus; and a recording medium having a noise cancellation program stored thereon to make a computer of the image forming apparatus implement the noise cancellation method.

2. Background Technology

The following description sets forth the inventor's knowledge of related art and problems therein and should not be construed as an admission of knowledge in the prior art.

The image forming apparatuses such as MFPs have various rotating portions loaded thereon, which cause operating noise while rotating, for example, motors and fans.

To control the rotation operation of such a rotating portion, a controller with a CPU, which is mounted on a control board inside an image forming apparatus inputs a control signal predetermined for each operation mode (for example, monochrome mode, color mode, or tough paper printing mode) into the rotating portion, and ensures the proper operation of the image forming apparatus and also reduces the noise level thereof by maintaining the rotation frequency of the rotating portion at an optimal value.

For example, right above a fuser of the image forming apparatus, there provided a fan that cools paper down and prevents paper from being stuck to the fuser. And thus, while cancelling out operating noise as described above, the controller ensures the best cooling performance and prevents paper from being stuck thereto, by changing a control signal to optimize the rotation frequency of the fan, based on any factors from the group consisting of “Monochrome or Color”, “Paper Type”, “Size”, “Single-sided or Both-sided”, “Finish Option (post-process such as “Stapled”)”, “Temperature Condition”, and the like.

However, with the feature of controlling the rotation frequency of a rotating portion with use of a predetermined control signal, it tends to be difficult to technically ensure a consistency of the rotation frequency (noise level) across different image forming apparatuses because of variability of individual rotating portions and the power-supply voltage provided, even with use of the same control signal.

To deal with such a trouble, there has conventionally been provided a technology, which is so-called ANC (Active Noise Control), to: collect operating noise of a rotating portion with use of a sound collector such as a microphone; generate noise control sound data with the same amplitude but with the inverted phase to the operating noise; and emit the sound with use of a speaker provided as a sound emitter in the vicinity of the rotating portion, so that the operating noise of the rotating portion can be effectively cancelled out (for example, Japanese Unexamined Patent Applications No. H04-169401 and No. 2003-007794). In addition, there has also been suggested a technology, which is so-called Feedback ANC, to: collect synthetic sound of operating noise of a rotating portion and noise control sound from a speaker, with use of a sound collector such as a microphone, and feed back the signal to the controller, so that the noise control sound data can be optimally adjusted based on the signal and thus the operating noise can be more effectively cancelled out.

With such an image forming apparatus that employs ANC to cancel out operating noise of a rotating portion, it has been conventionally practiced that when a predetermined operation mode is changed to a different mode, ANC needs to finish, then start again after the rotation frequency of the rotating portion returns to a steady rate, i.e. reaches an optimal value for the different operation mode.

The reason for that comes from the fact that it is not so easy to continue generating noise control sound data, which is to effectively cancel out operating noise of the rotating portion, while catching up with the transition of the rotation frequency of the rotating portion, since the rotation frequency changes (increases/decreases) in a linear manner. Specifically, it is not easy to do so by Feedback ANC. In other words, by Feedback ANC, sound data with the inverted phase to operating noise collected with use of a microphone is generated inside of the controller, the anti-phase sound data is outputted from a speaker so that the operating noise can be effectively cancelled out, which means that Feedback ANC is highly effective to cancel out noise with regularity. On the other hand, it is not so effective to cancel out noise without regularity which is caused during transition of the rotation frequency.

As a solution to the inconvenience, it is not appropriate to disable ANC only during transition of the rotation frequency of the rotating portion; the operating noise continues to be generated during all that time, and what is worse in that case, the operating noise becomes still more annoying if such transition occurs frequently.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image forming apparatus capable of cancelling out a rotating portion's operating noise by ANC even during transition of the rotation frequency of the rotating portion from a first rate to a second rate.

It is another object of the present invention to provide a noise cancellation method for the image forming apparatus capable of cancelling out a rotating portion's operating noise by ANC even during transition of the rotation frequency of the rotating portion from a first rate to a second rate.

It is yet another object of the preset invention to provide a recording medium having a noise cancellation program stored thereon to make a computer of the image forming apparatus implement the noise cancellation method.

According to a first aspect of the present invention, an image forming apparatus includes:

a sound-level meter that measures operating noise caused by a rotating portion that is the source of noise;
a sound data generator that generates a noise control sound data object with the same amplitude but with the inverted phase to the operating noise measured by the sound-level meter;
a speaker that emits noise control sound based on the noise control sound data object generated by the sound data generator;
a memory that stores in advance a noise control sound data object generated by the sound data generator to cancel out operating noise measured by the sound-level meter during transition of the rotation frequency of the rotating portion from a first rate to a second rate because of a change in the operation mode; and
a controller that makes the sound-level meter measure operating noise of the rotating portion and makes the sound data generator generate a noise control sound data object to cancel out the operating noise, then makes the speaker emit sound based on the noise control sound data object, while the rotating portion runs in steady state, meanwhile reads out from the memory, a suitable noise control sound data object stored thereon and makes the speaker emit sound based on the noise control sound data object, during the transition of the rotation frequency of the rotating portion.

According to a second aspect of the present invention, a noise cancellation method for the image forming apparatus includes:

measuring operating noise caused by a rotating portion that is the source of noise;
generating a noise control sound data object with the same amplitude but with the inverted phase to the measured operating noise;
emitting noise control sound from a speaker based on the generated noise control sound data object;
storing in advance on a memory, a noise control sound data object generated to cancel out operating noise measured during transition of the rotation frequency of the rotating portion from a first rate to a second rate because of a change in the operation mode; and
measuring operating noise of the rotating portion and generating a noise control sound data object to cancel out the operating noise, then emitting sound from the speaker based on the noise control sound data object, while the rotating portion runs in steady state, or alternatively reading out from the memory, a suitable noise control sound data object stored thereon and emitting sound from the speaker based on the noise control sound data object, during the transition of the rotation frequency of the rotating portion.

According to a third aspect of the present invention, a recording medium has a noise cancellation program stored thereon to make a computer of the image forming apparatus execute:

measuring operating noise caused by a rotating portion that is the source of noise;
generating a noise control sound data object with the same amplitude but with the inverted phase to the measured operating noise;
emitting noise control sound from a speaker based on the generated noise control sound data object;
storing in advance on a memory, a noise control sound data object generated to cancel out operating noise measured during transition of the rotation frequency of the rotating portion from a first rate to a second rate because of a change in the operation mode; and
measuring operating noise of the rotating portion and generating a noise control sound data object to cancel out the operating noise, then emitting sound from the speaker based on the noise control sound data object, while the rotating portion runs in steady state, or alternatively reading out from the memory, a suitable noise control sound data object stored thereon and emitting sound from the speaker based on the noise control sound data object, during the transition of the rotation frequency of the rotating portion.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram illustrating an electrical configuration of a MFP which is an image forming apparatus according to one mode of embodied implementation of the present invention;

FIG. 2 is a view to explain the principles of ANC;

FIG. 3 is a waveform diagram to explain operations performed by ANC;

FIG. 4 is a flowchart representing a processing routine to cancel out noise by ANC;

FIG. 5 is a characteristic chart indicating an example of transition of the rotation frequency of a fan that is a rotating portion;

FIG. 6 is a flowchart representing a processing routine to control the rotation frequency of the rotating portion during transition of the rotation frequency;

FIG. 7 is a characteristic chart indicating an example of transition of the rotation frequency of a motor which is a rotating portion;

FIG. 8 illustrates a table stored on a data memory, with a plurality of noise control sound data objects being therein;

FIG. 9 illustrates a table stored on a data memory, with a plurality of noise control sound data objects and the rotating portion's running time being therein;

FIG. 10 is a flowchart representing a processing routine to re-measure operating noise if there is a predetermined change in operating noise;

FIG. 11 is a view to explain how to correct a noise control sound data object, based on the amount of a change in the sound pressure level of operating noise if the change happens while the rotating portion runs in steady state;

FIG. 12 is a flowchart representing a processing routine to re-measure operating noise of the rotating portion during transition of the rotation frequency, and generate a noise control sound data object; and

FIG. 13 a flowchart representing a processing routine to re-measure operating noise of the rotating portion during transition of the rotation frequency, and generate a noise control sound data object.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinbelow, one mode of embodied implementation of the present invention will be described with reference to the accompanying figures.

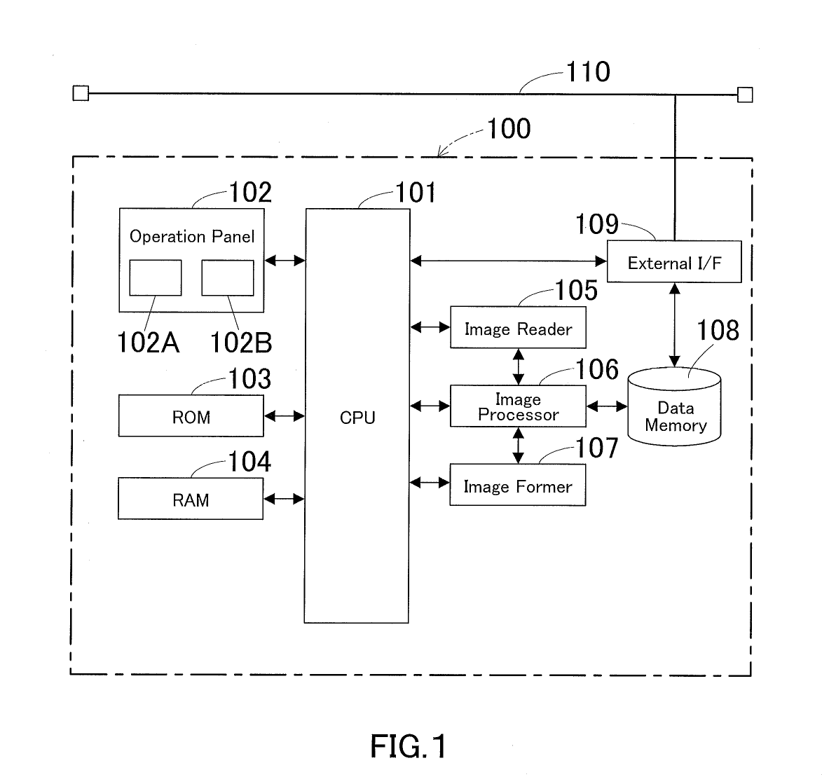

FIG. 1 is a block diagram illustrating an electrical configuration of a MFP 100 which is an image forming apparatus according to one mode of embodied implementation of the present invention.

As illustrated in FIG. 1, the MFP 100 is provided with a controller 101 including a CPU, an operation panel 102, a ROM 103, a RAM 104, an image reader 105, an image processor 106, an image former 107, a data memory 108, and an external interface (I/F) 109.

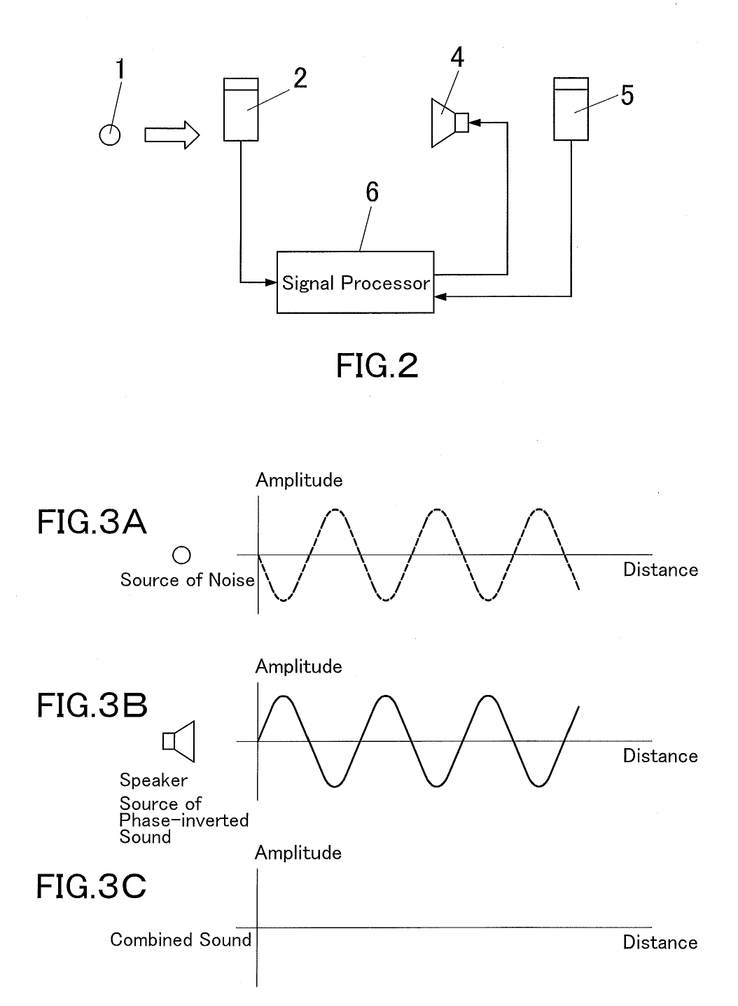

The controller 101 integrally controls all operations of the MFP 101. Specifically, in this mode of embodied implementation, it also judges whether or not a fan 1 (FIG. 2) runs in steady state, and enables ANC as described above. More specifically, the controller 101 measures operating noise of the fan 1 while the fan 1 runs in steady state, generates a noise control sound data object to cancel out the measured operating noise, and emits the sound from a speaker. While the rotating frequency of the fan 1 is changing from a certain level to another level, a suitable noise control sound data object is read out from the data memory 108, which stores a plurality of noise control sound data objects, and emits the sound from a speaker.

The operation panel 102 is provided with a display 102A such as a LCD, and a keyboard 102B. The display 102A is used to set various functions, and can display various messages thereon. The keyboard 102B includes a numerical keypad, a Start button, a Stop button, and the like.

The ROM 103 stores an operation program for the CPU of the controller 101.

The RAM 104 provides a work area for the CPU to execute processing according to an operation program.

The image reader 105 converts an image on a document or the like, into electronic data.

The image processor 106 performs a predetermined image process on the image data received from the image reader 105, and transfers it to the image former 108.

The image former 107 serves as an engine to print image data on paper according to a predetermined job condition.

The data memory 108 stores various data. Specifically, in this mode of embodied implementation, it also stores noise control sound data generated in advance, so that operating noise of the fan 1 serving as a rotating portion can be effectively cancelled out with use of it during transition of the rotation frequency. Furthermore, in this mode of embodied implementation, transition of the rotation frequency occurs in more than one case depending on how many operation modes the MFP 100 actually have, for example, it occurs when the operation mode is changed from stand-by mode to tough paper printing mode, and when the operation mode is changed from tough paper printing mode to regular paper printing mode. And accordingly, various noise control sound data objects are stored in advance so that an optimal one can serve in any case. Alternatively, only one noise control sound data object may be stored on the data storage 108, as a matter of course.

The external I/F 109 serves as a communicator that exchanges data with a user terminal connected via the network 111 such as an office's inside LAN, although the user terminal is not illustrated in this drawing.

The user identifier 110 detects the presence of a user in the vicinity of the MFP 100, for example, by an infrared sensor, and also detects a login user's ID by wireless communication and identifies the user with it.

As illustrated in FIG. 2, the MFP 100 includes: one or more than one fan 1 that serves as an rotating portion causing operating noise; a reference microphone 2 for noise collection that is provided in the vicinity of the fan 1; a signal processor 6 that generates sound signals (FIG. 3) with the same amplitude but with the inverted phase to the operating noise of the fan 1; a speaker 4 serving as a sounding body that emits the sound signals with the same amplitude but with the inverted phase to the operating noise, which is generated by the signal processor 6; and a microphone 5 for error detection that collects synthetic sound generated by mutual interference of the operating noise of the fan 1 and the sound from the speaker 4, and transmits the synthetic sound as feed back signals to the signal processor 6. All these portions jointly constitute an ANC machinery. The function of the signal processor 6 is implemented by the controller 101.

With reference to FIG. 2, the principles of ANC of the ANC machinery will be described herein below. Operating (rotating) noise of the fan 1 that is a source of noise here, is measured by the reference microphone 2, then analyzed by the signal processor 6. And noise control sound data illustrated in FIG. 3B with the same amplitude but with the inverted phase to the operating noise illustrated in FIG. 3A is generated by the signal processor 6, then outputted by the speaker 4. And as illustrated in FIG. 3C, the operating noise of the fan 1 and the noise control sound from the speaker 4 interfere with each other, and by this principle, the operating noise of the fan 1 is cancelled out.

Furthermore, synthetic sound generated by mutual interference of the operating noise of the fan 1 and the noise control sound from the speaker 4 is detected by the microphone 5, then signals of the detected synthetic sound are fed back to the signal processor 6. Receiving the signals, the signal processor 6 optimally adjusts the amplitude and the phase of the noise control sound, which ensures a perfect noise control effect on the operating noise of the fan 1.

The microphone 5 for error detection may be unnecessary, for example, when feedback control is not enabled.

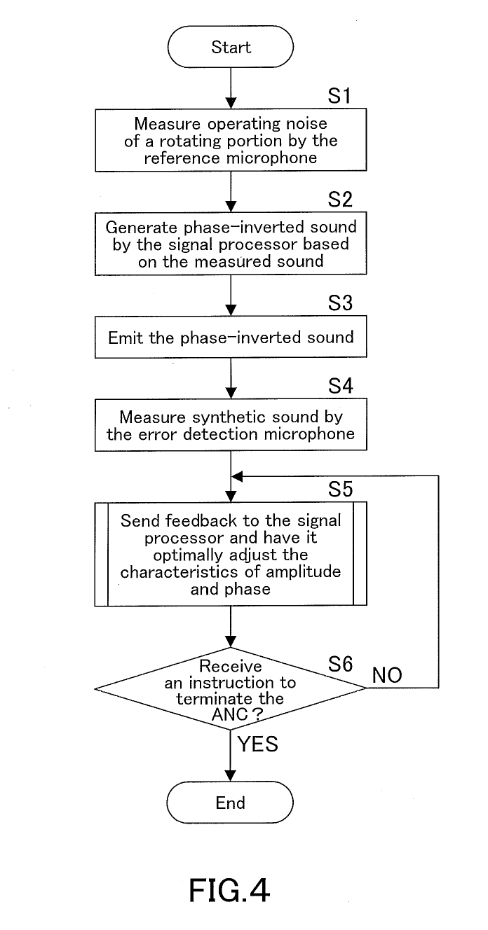

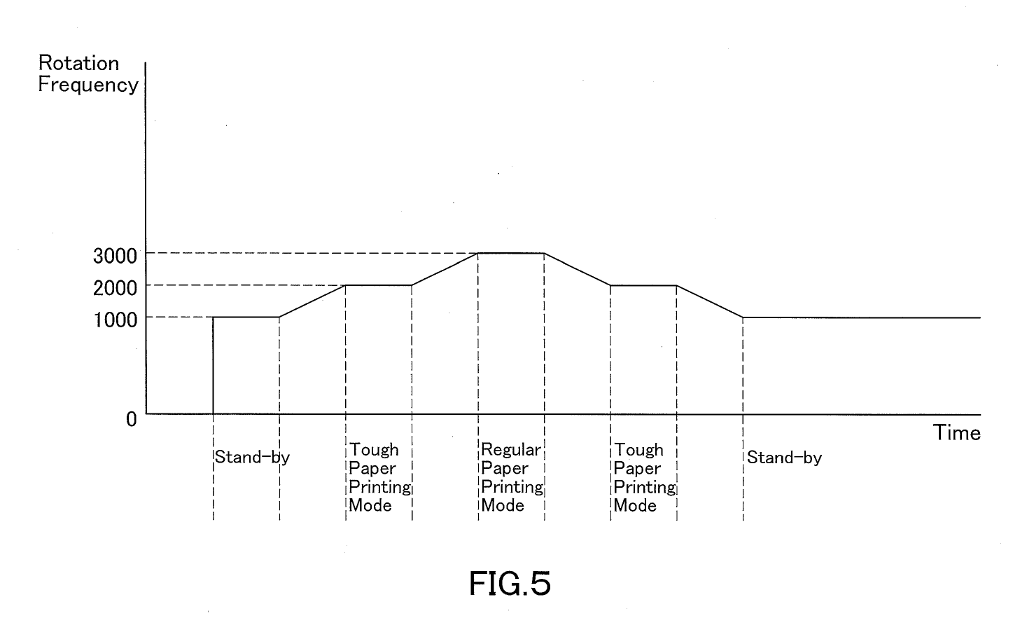

FIG. 4 is a flowchart representing a processing routine to cancel out noise by ANC.

In Step S1 in FIG. 4, operating noise of the fan 1 is measured by the microphone 2. And noise control sound data with the same amplitude but with the inverted phase to the measured operating noise is generated by the signal processor 6 in Step S2. In Step S3, the generated noise control sound data is outputted by the speaker 4, so that the operating noise of the fan 1 and the sound from the speaker 4 will interfere with each other.

In Step S4, the synthetic sound of the operating noise of the fan 1 and the noise control sound from the speaker 4 is further measured by the microphone 5 for error detection. And in Step 5, the measured synthetic sound is fed back to the signal processor 6, and thereby the characteristics of the amplitude and the phase of the noise control sound data are optimally adjusted.

In Step S6, it is judged whether or not there is an instruction to finish the process. If there is no such instruction (NO in Step S6), the routine goes back to Step S5. If there is such an instruction (YES in Step S6), the routine immediately terminates.

FIG. 5 is an example of a characteristic chart illustrating of the rotation frequency of the fan 1 for cooling down paper for example, which is provided on the fuser for example, of the MFP 100.

The rotation frequency of the fan 1 is adjusted to an optimal level of air volume and an acceptable level of operating noise, depending on the current operation mode of the MFP 100.

In this mode of embodied implementation, the rotation frequency of the fan 1 is adjusted to: “1,000” when the MFP 100 is in stand-by mode; “2,000” in tough paper printing mode, i.e. when “tough paper” is selected as the paper to feed for printing; and “3,000” in regular paper printing mode, i.e. when “regular paper” is selected as the paper to feed for printing. Therefore, when the operation mode is changed from stand-by mode to tough paper printing mode and a print instruction is given, the rotation frequency of the fan 1 will be switched from “1,000” to “2,000” accordingly. This case of transition of the rotation frequency is referred to as “stand-by to tough paper mode” case. When the operation mode is changed to regular paper printing mode during printing tough paper, the rotation frequency of the fan 1 will be switched from 2,000 to 3,000 accordingly. This case of transition of the rotation frequency is referred to as “tough paper to regular paper mode” case.

As well as these cases of transition of the rotation frequency, there are “regular paper to tough paper mode” case, “tough paper to stand-by mode” case, “stop to stand-by mode” case, “stand-by to stop mode” case, and the like, depending on what operation modes the MFP 100 actually have.

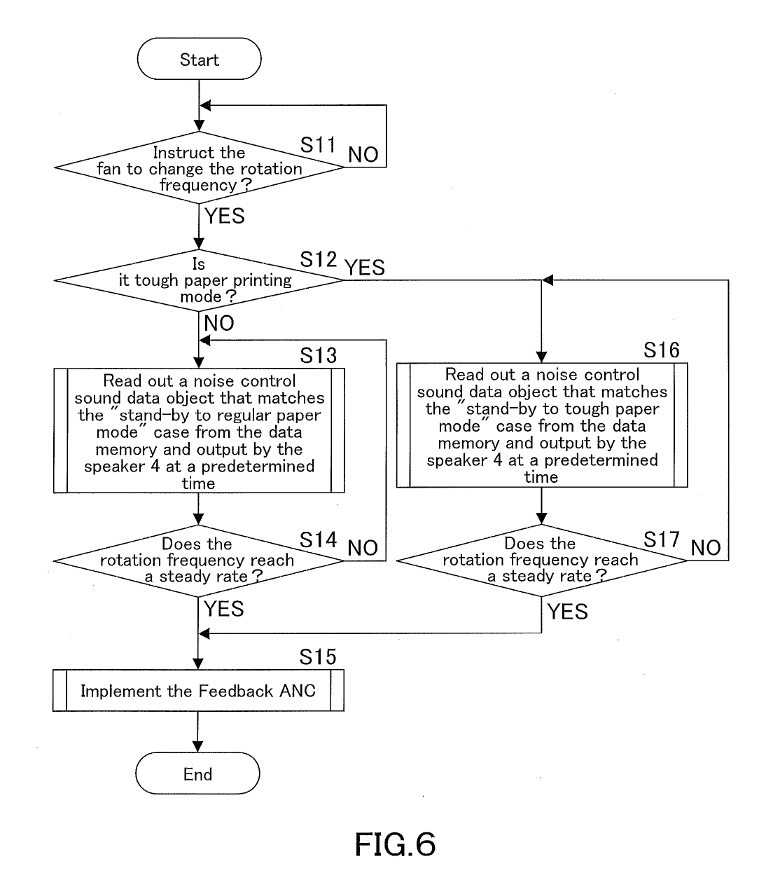

FIG. 6 is a flowchart representing a ANC processing to control the rotation frequency of the fan 1 during transition of the rotation frequency when the operation mode of the MFP 100 is changed. The flowcharts in FIG. 6 and the following drawings are executed by the CPU 101 of the MFP 100 according to an operation program stored on a recording medium such as the ROM 103. The flowchart in FIG. 6 is executed when a print instruction is given while the MFP 100 is in stand-by mode.

In Step S11 in FIG. 6, it is judged whether or not an instruction to change the rotation frequency is given to the fan 1 currently rotating at a constant rate in stand-by mode (an instruction to change the operation mode). If no such instruction is given (NO in Step S11), the routine waits until it is given. If such an instruction is given (YES in Step S11), the routine proceeds to Step S12.

In Step S12, it is judged whether or not tough paper printing mode is selected as the operation mode. If tough paper printing mode is not selected (NO in Step S12), a noise control sound data object that matches the “stand-by to regular paper mode” case is read out from the data memory 108 and outputted by the speaker 4 at a predetermined time, in Step S13. It is necessary to preliminarily measure the actual operating noise in the “stand-by to regular paper mode” case, generate a noise control sound data object based on the measured operating noise, and store it on the data memory 108. The noise control sound data object is exactly what is read out from the data memory 108 in Step S13, and it is with the same amplitude but with the inverted phase to the operating noise. By outputting the noise control sound data object by the speaker 4, the operating noise of the fan 1 caused during transition of the rotation frequency is cancelled out.

And then, it is judged in Step S14, whether or not the rotation frequency of the fan 1 reaches a steady rate. If it does not reach a steady rate (NO in Step S14), the routine goes back to Step S13. If it reaches a steady rate (YES in Step S14), the routine proceeds to Step S15.

If in Step S12, tough paper printing mode is selected as the operation mode (YES in Step S12), a noise control sound data object that matches the “stand-by to tough paper mode) case is read out from the data memory 108 and outputted by the speaker 4 at a predetermined time, in Step S16. It is necessary to preliminarily measure the actual operating noise in the “stand-by to tough paper mode” case, generate a noise control sound data object based on the measured operating noise, and store it on the data memory 108. The noise control sound data object is exactly what is read out from the data memory 108 in Step S16, and it is with the same amplitude but with the inverted phase to the operating noise. By outputting the noise control sound data object by the speaker 4, the operating noise of the fan 1 caused during transition of the rotation frequency is cancelled out.

And then, it is judged in Step S17, whether or not the rotation frequency of the fan 1 reaches a steady rate. If it does not reach a steady rate (NO in Step S17), the routine goes back to Step 16. If it reaches a steady rate (YES in Step S17), the routine proceeds to Step S15.

Feedback ANC is implemented in Step S15, because the rotation frequency of the fan 1 has reached a steady rate.

As described above, while the fan 1 runs in steady state, operating noise is measured and a suitable noise control sound data object is generated at the same time, and the generated sound data object is outputted by the speaker 4. In this way, the operating noise of the fan 1 can be cancelled out by ANC.

Meanwhile, during transition of the rotation frequency of the fan 1, a noise control sound data object that matches the current transition case is read out from the data memory 108 and outputted by the speaker 4. In this way, operating noise even without regularity which is caused during transition of the rotation frequency can be effectively cancelled out by ANC.

The rotating portion employed herein as a source of noise is not limited to the fan 1. It may be a motor, for example.

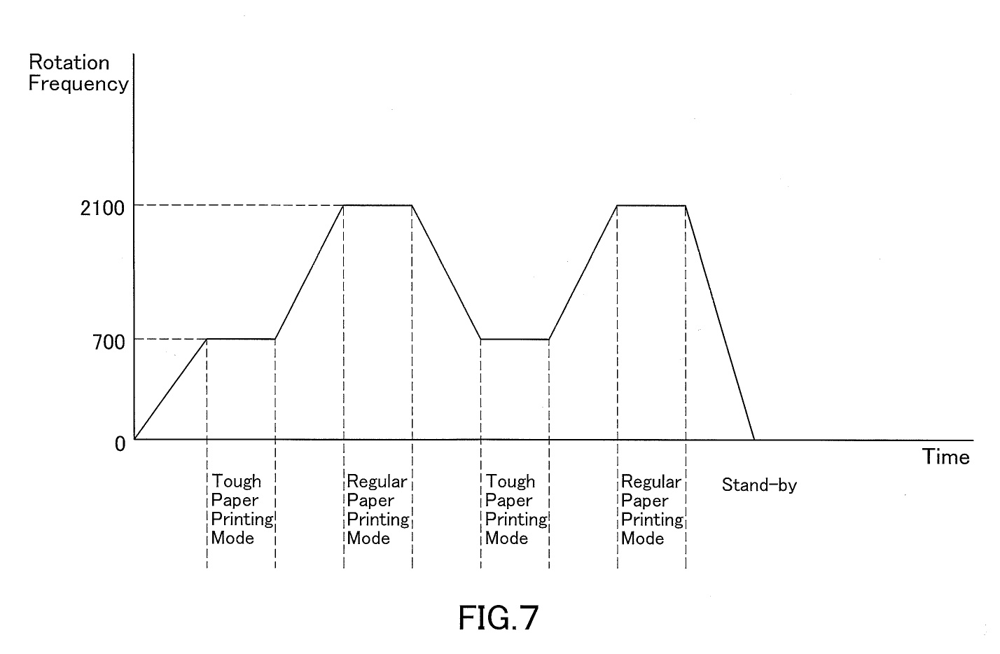

FIG. 7 is a characteristic chart indicating an example of transition of the rotation frequency of a motor that serves for paper conveyance.

The rotation frequency of the motor serving for paper conveyance in FIG. 7 is adjusted to an optimal conveyance rate, depending on the current operation mode of the MFP 100.

In this example, the rotation frequency of the motor is adjusted to “700” in tough paper printing mode, and “2,100” in regular paper printing mode.

As in the case of a fan, there are cases of transition of the rotation frequency of a motor, “stand-by to tough paper mode” case, “tough paper to regular paper mode” case, “regular paper to tough paper mode” case, “regular paper to stand-by mode” case, and the like.

Furthermore, in this example, as in ANC processing in the flowchart in FIG. 6, a noise control sound data object that matches the current transition case is read out from the data memory 108 and outputted by the speaker 4 in any transition cases.

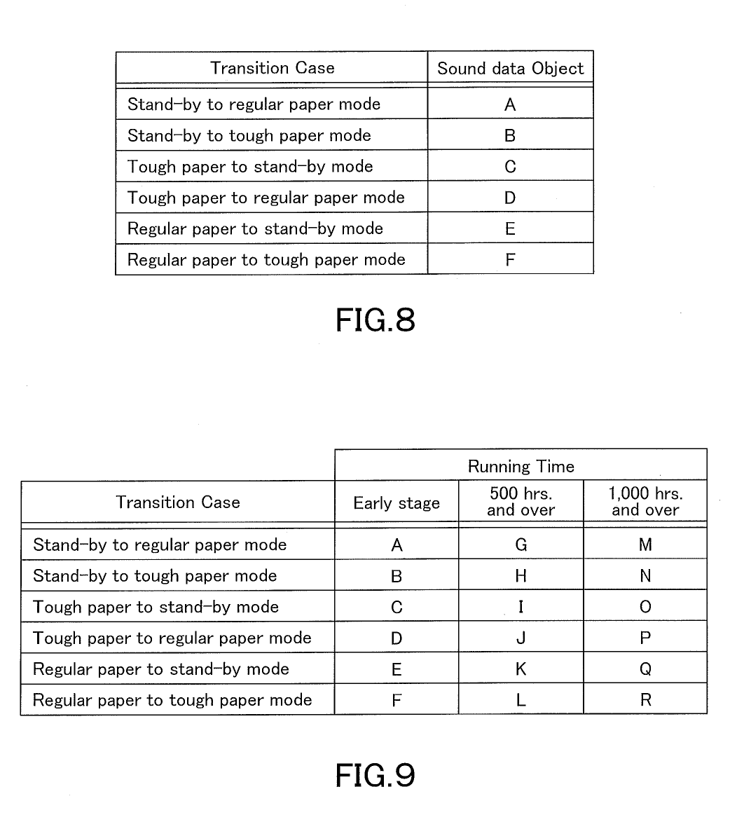

FIG. 8 illustrates a table stored on the memory 108, with a plurality of noise control sound data objects being therein; noise control sound data objects A, B, C, D, E, and F that match the “stand-by to regular paper mode” case, the “stand-by to tough paper mode” case, the “tough paper to stand-by mode” case, the “tough paper to regular paper mode” case, the “regular paper to stand-by mode” case, and the “regular paper to tough paper mode” case are stored in advance, respectively. According to this table, the noise control sound data object A is read out from the memory and outputted by the speaker 4 in the “stand-by to regular paper mode” case, and the noise control sound data object B is read out from the memory and outputted by the speaker 4 in the “stand-by to tough paper mode” case. A suitable sound data object also depends on the source of noise. For example, if the source of noise is a fan, a suitable sound data object for the fan is outputted.

The ANC processing is not limited to these transition cases relating to the printing modes. It should be noted that the ANC processing also can be applied to another transition case in which, for example, the picture quality is changed from 600 dpi to 1,200 dpi.

FIG. 9 illustrates a table stored on the data memory 108, with a plurality of noise control sound data objects and their attributes of the rotating portion's running time.

According to FIG. 9, for example, in the same “stand-by to regular paper mode” case: the noise control sound data object A is outputted in the early stage of running of the rotating portion; the noise control sound data object G is outputted on and over 500 hours of running time; and the noise control sound data object M is outputted on and over 1,000 hours of running time, respectively.

In this example, different noise control sound data objects that match one transition case depending on the rotating portion's running time, are preliminarily generated and stored on the data memory 108. Alternatively, different noise control sound data objects that match one transition case depending on another operating condition such as total number of sheets to be outputted, and/or an environmental condition such as temperature or humidity, may be preliminarily generated and stored on the data memory 108.

Only if a plurality of and different noise control sound data objects that match one transition case depending on a rotating portion's operating condition and/or an environmental condition, are stored in advance as described above, any operating noise of the rotating portion can be effectively cancelled out with a noise control sound data object that perfectly matches the level of age-related degradation of the rotating portion.

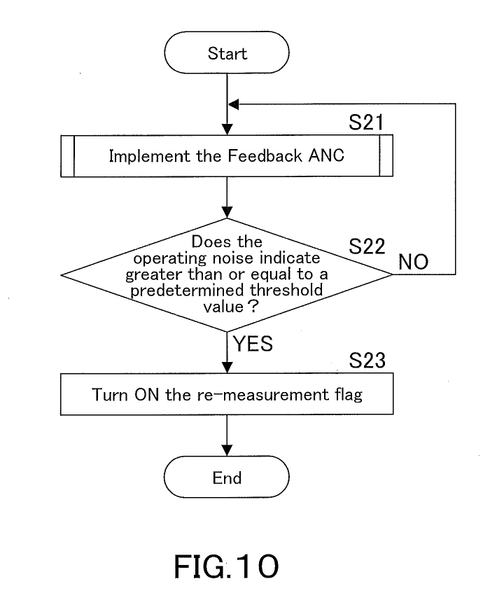

FIG. 10 is a flowchart representing a processing routine to re-measure operating noise during transition of the rotation frequency, if there is a predetermined change in operating noise while the rotating portion runs in steady state.

In Step S21 in FIG. 10, while a rotating portion such as the fan 1 runs in steady state, operating noise of the fan 1 is measured by Feedback ANC.

While operating noise of the fan 1 is measured, it is judged in Step S22 whether or not the sound pressure level of the operating noise indicates greater than or equal to a predetermined threshold value. If it indicates smaller than predetermined threshold value (NO in Step S22), the routine goes back to Step S21 and still continues ANC. If the sound pressure level of the operating noise indicates greater than or equal to a predetermined threshold value (YES in Step S22), the re-measurement flag is turned ON in Step S23, so that operating noise will be re-measured in a set of relevant transition cases.

If the re-measurement flag is turned ON in Step S23; the MFP 100 will re-measure operating noise in a set of relevant transition cases and generate noise control sound data objects based on the measured operating noise, when performing its first operation in an operation mode after being powered ON or coming back from sleep mode.

Alternatively, the MFP 100 may correct an original noise control sound data object stored in advance on the data memory 108, based on the amount of a change in the sound pressure level of operating noise if the change happens while the rotating portion runs in steady state.

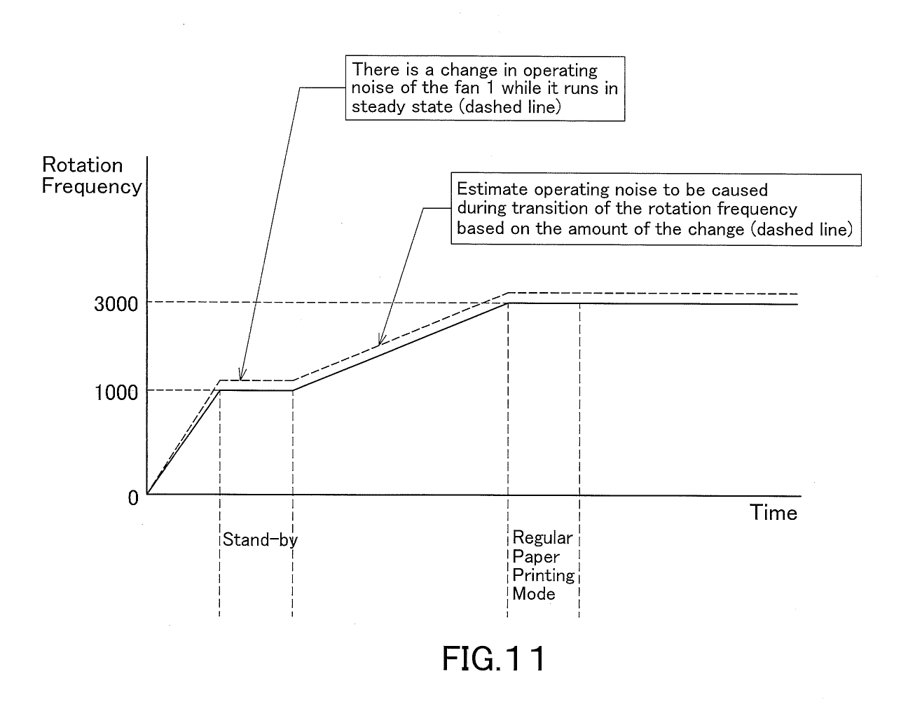

FIG. 11 is a view to explain how to correct a noise control sound data object stored in advance on the data memory 108, based on the amount of a change in the sound pressure level of operating noise if the change happens while the rotating portion runs in steady state.

For example, as indicated by dashed line in FIG. 11, if there is a change in operating noise of the fan 1 while the MFP 100 is in stand-by mode, operating noise to be caused by the fan 1 in the next operation mode while it runs in steady state is estimated based on the amount of the change, and the original noise control sound data object that matches each relevant transition case is corrected based on the estimated value.

As described above, if there is a change in operating noise while a rotating portion runs in steady state, an original noise control sound data object is corrected, and the changed operating noise can be effectively cancelled out with its perfectly matching sound data object.

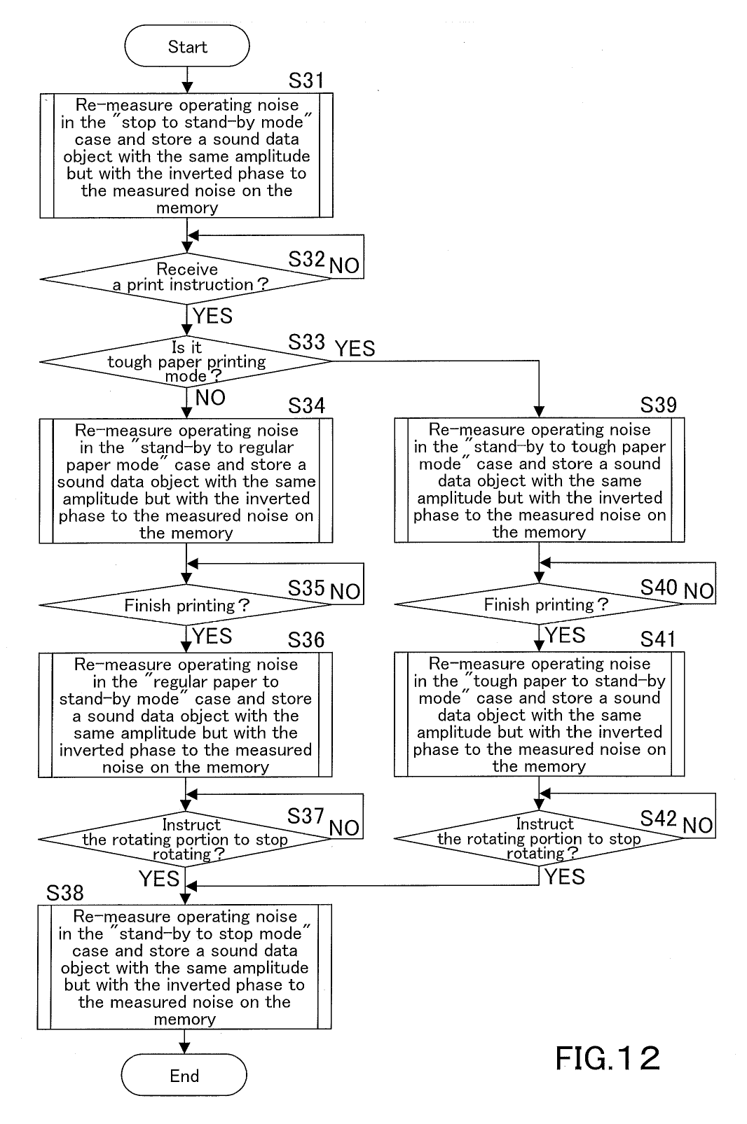

FIG. 12 is a flowchart representing a processing routine executed if the re-measurement flag is turned ON in Step S23 in FIG. 10, and in the processing routine, after being powered ON or coming back from sleep mode, the MFP 100 re-measures operating noise of the rotating portion in a set of relevant transition cases and generates noise control sound data objects based on the measured operating noise, when performing its first operation in an operation mode.

In this example, the MFP 100 has tough paper printing mode and regular paper printing mode, but the operation modes of the MFP 100 are not limited to them.

In Step S31, operating noise of a rotating portion such as the fan 1 is re-measured in the “stop to stand-by mode” case, then a noise control sound data object with the same amplitude but with the inverted phase to the measured operating noise is generated to be stored on the data memory 108. And the new generated noise control sound data object is stored on the data memory 108, in other words, the original noise control sound data object preliminarily stored thereon for this transition case is replaced with the new generated one.

In Step S32, it is judged whether or not there is a print instruction. If there is no print instruction (NO in Step S32), the routine waits until it is given. If there is a print instruction (YES in Step S32), then it is judged in Step S33 whether or not tough paper printing mode is selected as the operation mode.

If tough paper printing mode is not selected (NO in Step S33), the routine proceeds to Step S34, in which operating noise of the fan 1 is re-measured in the “stand-by to regular printing mode” case, then a noise control sound data object with the same amplitude but with the inverted phase to the measured operating noise is generated and stored on the data memory 108. After that, the routine proceeds to Step S35.

In Step S35, it is judged whether or not regular paper printing is finished. If it is not finished yet (NO in Step S35), the routine waits until finished. If regular paper printing is finished (YES in Step S35), the routine proceeds to Step S36, in which operating noise is re-measured in the “regular paper to stand-by mode” case, then a noise control sound data object with the same amplitude but with the inverted phase to the measured operating noise is generated and stored on the data memory 108. After that, the routine proceeds to Step S37.

In Step S37, it is judged whether or not an instruction to stop rotating is given to the rotating portion. If no such instruction is given (NO in Step S37), the routine waits until it is given. If such an instruction is given (YES in Step S37), the routine proceeds to Step S38, in which operating noise is re-measured in the “stand-by to stop mode” case, then a noise control sound data object with the same amplitude but with the inverted phase to the measured operating noise is generated and stored on the data memory 108. After that, the routine terminates.

If tough paper printing mode is selected as the operation mode (YES in Step S33), the touring proceeds to Step S39, in which operating noise of the fan 1 is re-measured in the “stand-by to tough printing mode” case, then a noise control sound data object with the same amplitude but with the inverted phase to the measured operating noise is generated and stored on the data memory 108. After that, the routine proceeds to Step S40.

In Step S40, it is judged whether or not tough paper printing is finished. If it is not finished yet (NO in Step S40), the routine waits until finished. If tough paper printing is finished (YES in Step S40), the routine proceeds to Step S41, in which operating noise is re-measured in the “tough paper to stand-by mode” case, then a noise control sound data object with the same amplitude but with the inverted phase to the measured operating noise is generated and stored on the data memory 108. After that, the routine proceeds to Step S42.

In Step S42, it is judged whether or not an instruction to stop rotating is given to the rotating portion. If no such instruction is given (NO in Step S42), the routine waits until it is given. If such an instruction is given (YES in Step S42), the routine proceeds to S38, in which operating noise is re-measured in the “stand-by to stop mode” case, then a noise control sound data object with the same amplitude but with the inverted phase to the measured operating noise is generated and stored on the data memory 108. After that, the routine terminates.

As described above, if there is a change in operating noise while a rotating portion runs in steady state, a suitable noise control sound data object is generated again, and the changed operating noise can be effectively cancelled out with its perfectly matching sound data object.

Instead of directly from stand-by mode to tough paper printing mode, the operation mode may be changed from stand-by mode to tough paper printing mode via regular paper printing mode, in Step S39. Similarly, it may be changed from tough paper printing mode to stand-by mode via regular paper printing mode, in Step S41. In this alternative process, noise control sound data objects that match the “tough paper to regular paper mode” case and the “stand-by to regular paper mode” case are additionally generated and stored on the data memory 108, in Steps S39 and S41, respectively.

As described with reference to FIG. 12, the MFP 100 re-measures operating noise of the rotating portion in a set of relevant transition cases and generates new suitable noise control sound data objects, when it is back to normal. Alternatively, the MFP 100 may re-measure operating noise in a set of relevant transition cases and generates noise control sound data objects based on the measured values, by running a test operation.

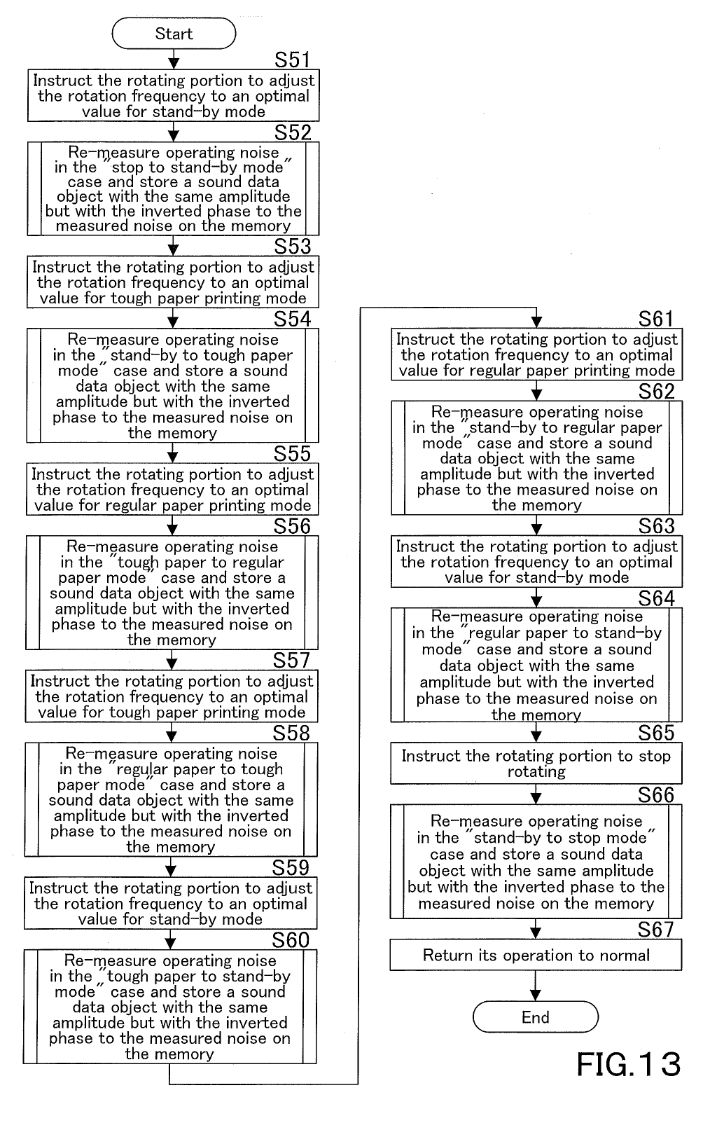

This alternatively process will be described with reference to a flowchart illustrated in FIG. 13.

In FIG. 13, the MFP 100 re-measures operating noise in a set of relevant transition cases and generates suitable noise control sound data objects, by running a test operation in an operation mode after being powered ON or coming back from sleep mode.

In Step S51, a rotating portion such as the fan 1 is instructed to adjust the rotation frequency to an optimal value for stand-by mode. And in Step S52, operating noise is re-measured in the “stop to stand-by mode” case, then a noise control sound data object with the same amplitude but with the inverted phase to the measured operating noise is generated and stored on the data memory 108.

In Step S53, the rotating portion is instructed to adjust the rotation frequency to an optimal value for tough paper printing mode. And in Step S54, operating noise is re-measured in the “stand-by to tough paper mode” case, then a noise control sound data object with the same amplitude but with the inverted phase to the measured operating noise is generated and stored on the data memory 108.

In Step S55, the rotating portion is instructed to adjust the rotation frequency to an optimal value for regular paper printing mode. And in Step S56, operating noise is re-measured in the “tough paper to regular paper mode” case, then a noise control sound data object with the same amplitude but with the inverted phase to the measured operating noise is generated and stored on the data memory 108.

In Step S57, the rotating portion is instructed to adjust the rotation frequency to an optimal value for tough paper printing mode. And in Step S58, operating noise is re-measured in the “regular paper to tough paper mode” case, then a noise control sound data object with the same amplitude but with the inverted phase to the measured operating noise is generated and stored on the data memory 108.

In Step S59, the rotating portion is instructed to adjust the rotation frequency to an optimal value for stand-by mode. And in Step S60, operating noise is re-measured in the “tough paper to stand-by mode” case, then a noise control sound data object with the same amplitude but with the inverted phase to the measured operating noise is generated and stored on the data memory 108.

In Step S61, the rotating portion is instructed to adjust the rotation frequency to an optimal value for regular paper printing mode. And in Step S62, operating noise is re-measured in the “stand-by to regular paper mode” case, then a noise control sound data object with the same amplitude but with the inverted phase to the measured operating noise is generated and stored on the data memory 108.

In Step S63, the rotating portion is instructed to adjust the rotation frequency to an optimal value for stand-by mode. And in Step S64, operating noise is re-measured in the “regular paper to stand-by mode” case, then a noise control sound data object with the same amplitude but with the inverted phase to the measured operating noise is generated and stored on the data memory 108.

In Step S65, the rotating portion is instructed to stop rotating. And in Step S6, operating noise is re-measured in the “stand-by to stop mode” case, then a noise control sound data object with the same amplitude but with the inverted phase to the measured operating noise is generated and stored on the data memory 108.

Finally, the MFP 100 returns its operation to normal in Step S67, then the routine terminates the test operation.

In this mode of embodied implementation, the MFP 100 re-measures operating noise and runs a test operation after being powered ON or coming back from sleep mode. However, the time of re-measuring operating noise and running a test operation is not limited to this mode of embodied implementation. Instead, the MFP 100 may re-measure operating noise and run a test operation during a warm-up period after being powered ON or coming back from sleep mode. Also, by running the rotating portion such as the fan 1, the MFP 100 may re-measure operating noise and run a test operation during an image stabilization period. Alternatively, MFP 100 may re-measure operating noise and run a test operation, for example, right before the start of printing or right after the end of printing, at a predetermined time, or at a particular beep sound noticing the end of printing or facsimile reception.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming apparatus comprising:
a sound-level meter that measures operating noise caused by a rotating portion that is the source of noise;
a sound data generator that generates a noise control sound data object with the same amplitude but with the inverted phase to the operating noise measured by the sound-level meter;
a speaker that emits noise control sound based on the noise control sound data object generated by the sound data generator;
a memory that stores in advance a noise control sound data object generated by the sound data generator to cancel out operating noise measured by the sound-level meter during transition of the rotation frequency of the rotating portion from a first rate to a second rate because of a change in the operation mode; and
a controller that makes the sound-level meter measure operating noise of the rotating portion and makes the sound data generator generate a noise control sound data object to cancel out the operating noise, then makes the speaker emit sound based on the noise control sound data object, while the rotating portion runs in steady state, meanwhile reads out from the memory, a suitable noise control sound data object stored thereon and makes the speaker emit sound based on the noise control sound data object, during the transition of the rotation frequency of the rotating portion.

2. The image forming apparatus as recited in claim 1, wherein the noise control sound data object read out from the memory has the same amplitude but the inverted phase to the operating noise that is measured by the sound-level meter during the transition of the rotation frequency of the rotating portion.

3. The image forming apparatus as recited in claim 1, wherein:
there are a plurality of cases of transition of the rotation frequency of the rotating portion if the image forming apparatus has a plurality of operation mode, a plurality of noise control sound data objects that match the transition cases one by one are preliminarily stored on the memory; and
the controller reads out from the memory, a noise control sound data object that matches the current transition case during transition of the rotation frequency of the rotating portion.

4. The image forming apparatus as recited in claim 3, wherein a plurality of and different noise control sound data objects that match one transition case depending on the rotating portion's operation condition and/or environmental condition, are preliminarily stored on the memory.

5. The image forming apparatus as recited in claim 1, wherein if there is a change in operating noise of the rotating portion while it runs in steady state, the controller makes the sound-level meter re-measure operating noise of the rotating portion during the transition of the rotation frequency of the rotating portion and makes the sound data generator generate a noise control sound data object to cancel out the operating noise, or the controller makes the sound data generator correct an original noise control sound data object preliminarily stored on the memory.

6. The image forming apparatus as recited in claim 5, wherein the sound data generator estimates operating noise to be caused by the rotating portion in the next operation mode while it runs in steady state, and corrects the original noise control sound data object based on the estimated value.

7. The image forming apparatus as recited in claim 1, wherein the noise control sound data object stored on the memory is generated based on operating noise that is measured during transition of the rotation frequency of the rotating portion, when the image forming apparatus performs its first operation in each operation mode after being powered ON or coming back from sleep mode.

8. The image forming apparatus as recited in claim 1, wherein the noise control sound data object stored on the memory is generated based on operating noise that is measured during transition of the rotation frequency of the rotating portion, by running a test operation in each operation mode after the image forming apparatus is powered ON or comes back from sleep mode.

9. The image forming apparatus as recited in claim 8, wherein the image forming apparatus runs a test operation during a warm-up period after being powered ON or coming back from sleep mode.

10. The image forming apparatus as recited in claim 1, wherein the noise control sound data object stored on the memory is generated based on operating noise that is measured during transition of the rotation frequency of the rotating portion, when the image forming apparatus performs image stabilization.

11. The image forming apparatus as recited in claim 1, wherein the noise control sound data object stored on the memory is generated based on operating noise that is measured during transition of the rotation frequency of the rotating portion, right before the start of printing or right after the end of printing.

12. The image forming apparatus as recited in claim 1, wherein the noise control sound data object stored on the memory is generated based on operating noise that is measured during transition of the rotation frequency of the rotating portion, by running a test operation in each operation mode, staring at a predetermined time.

13. The image forming apparatus as recited in claim 1, wherein the noise control sound data object stored on the memory is generated based on operating noise that is measured during transition of the rotation frequency of the rotating portion, by running a test operation in each operation mode, starting at a particular beep sound.

14. A noise cancellation method for an image forming apparatus comprising:
measuring operating noise caused by a rotating portion that is the source of noise;
generating a noise control sound data object with the same amplitude but with the inverted phase to the measured operating noise;
emitting noise control sound from a speaker based on the generated noise control sound data object;
storing in advance on a memory, a noise control sound data object generated to cancel out operating noise measured during transition of the rotation frequency of the rotating portion from a first rate to a second rate because of a change in the operation mode; and
measuring operating noise of the rotating portion and generating a noise control sound data object to cancel out the operating noise, then emitting sound from the speaker based on the noise control sound data object, while the rotating portion runs in steady state, or alternatively reading out from the memory, a suitable noise control sound data object stored thereon and emitting sound from the speaker based on the noise control sound data object, during the transition of the rotation frequency of the rotating portion.

15. A non-transitory computer-readable recording medium having a noise cancellation program stored thereon to make a computer of an image forming apparatus execute:
measuring operating noise caused by a rotating portion that is the source of noise;
generating a noise control sound data object with the same amplitude but with the inverted phase to the measured operating noise;
emitting noise control sound from a speaker based on the generated noise control sound data object;
storing in advance on a memory, a noise control sound data object generated to cancel out operating noise measured during transition of the rotation frequency of the rotating portion from a first rate to a second rate because of a change in the operation mode; and
measuring operating noise of the rotating portion and generating a noise control sound data object to cancel out the operating noise, then emitting sound from the speaker based on the noise control sound data object, while the rotating portion runs in steady state, or alternatively reading out from the memory, a suitable noise control sound data object stored thereon and emitting sound from the speaker based on the noise control sound data object, during the transition of the rotation frequency of the rotating portion.
